(19) United States
(12) Patent Application Publication
(10) Pub. No.: US 2004/0033293 A1
(43) Pub. Date: Feb. 19, 2004

(54) Decorated food product

(75) Inventor: Bradley S. Albert, Bangor, PA (US)

Correspondence Address: FITZPATRICK CELLA HARPER & SCINTO, 30 ROCKEFELLER PLAZA, NEW YORK, NY, 10112, US

(73) Assignee: MARS, INCORPORATED, McLean, VA

(21) Appl. No.: 10/364,521

(22) Filed: Feb. 12, 2003

Related U.S. Application Data
(60) Provisional application No. 60/402,922, filed on Aug. 14, 2002.

(51) Int. Cl. A23G 1/00

(52) U.S. Cl. 426/103

(57) ABSTRACT

A decorated food product includes is formed from an edible product and an edible glitter affixed to the product by an edible adhesive. The edible glitter may be a combination of a food grade colorant and at least one of a sugar, a non-caloric sweetener, a gum, a gelatin, and a polysaccharide. Before drying, the edible adhesive may be a solution of a sugar and a polysaccharide. The decorated food product may be made by applying an edible adhesive to an edible product, and applying an edible glitter to the adhesive, thereby affixing the edible glitter to the edible product.

### RELATED APPLICATION

This application claims benefit of U.S. Provisional Application No. 60/402,922, filed Aug. 14, 2002.

### BACKGROUND OF THE INVENTION

1. Field of the Invention

The present invention is directed to decorated food products, and to a method of making such food products. In particular, the invention is directed to food products having at least one decoration affixed to their outer surface with an edible adhesive.

2. Related Background Art

Decorating articles with glitter is known. For example, U.S. Pat. No. 6,200,410 and U.S. Patent Application Publication No. US 2001/0047847 to Kukof disclose a method of making a light-reflective decorative article in which a light-reflecting foil is coated with an adhesive substance that is fixed on the foil to form an adhesive-coated foil. The foil is then cut to form a multitude of glitter flakes, a curable adhesive is applied to areas of a base material to be glittered, the glitter flakes are applied, and the adhesive is heat cured at a temperature of from 300° to 400° F. Clearly, the disclosed method is not suitable for decorating heat sensitive food products.

U.S. Pat. Nos. 5,514,384, 5,480,479, and 5,591,455 to Signorino disclose a wet powder, edible, film forming composition for coating tablets, capsules, and the like. The composition consists essentially of powdered pigment particles, a film-forming, water soluble or water dispersible, edible polymer, and water. The polymer component may be methyl cellulose, hydroxypropylmethyl cellulose, hydroxypropyl cellulose, polyvinyl pyrrolidone, maltodextrin, polydextrose, modified starches, and natural gums, such as gum tragacanth, gum acacia, and xanthan gum.

U.S. Pat. Nos. 5,643,667, 5,773,638, and 5,895,682 to Tsukioka disclose hot stamping edible gold or silver images onto edible substrates. The hot stamp material used to provide the images includes an inner release layer, an intermediate layer of gold or silver, and an outer adhesive layer. The adhesive layer is preferably shellac, but may be starch syrup, carboxymethyl starch, carboxymethyl cellulose, food gums, sodium alginates, food natural resins, or other natural food products. A layer of edible food product may be hot stamped with gold or silver on opposite sides, shredded, and applied to a food product.

PCT Publication No. WO 02/19987 to Chr. Hansen, Inc., discloses a dry powder film coating for pharmaceuticals and confectioneries containing gum-acacia, as a film former, a cellulosic polymer, such as hydroxypropyl methylcellulose, a plasticizer, such as propylene glycol, and, optionally, a pigment, such as titanium dioxide, FD&C aluminum lakes, natural colorants, and synthetic oxides. The dry powder film forming composition is formed by mixing the gum acacia, cellulosic polymer, and plasticizer. Prior to use, the dry powder is added to boiling water under agitation, and then diluted with cold water to obtain the desired concentration.

U.S. Pat. No. 6,231,900 to Hanke discloses a confectionery comprising distinct coolant and flavor compositions. The confectionery can be in the form of hard of soft candies, chewing gum, and pastilles. At least one region of the confectionery consists of a coolant composition, and at least one region consists of a flavor composition. Either composition can form a coating that may or may not be continuous, or may form discreet particles, such as a sugar coating. One disclosed method of making pastilles comprises molding the flavor composition in a starch mold, drying the molded composition, and removing it from the molds. The molded composition is then treated with steam to soften the surface, and tumbled with sugar crystals treated with a cooling agent. The crystals adhere to the softened pastille surface.

Presently, to add color to confectioneries, such as shelled chocolates, a water based solution or suspension of a dye or Lake is splattered onto the confectioneries to provided a speckled appearance. However, only one color may be applied at a time, and must be substantially completely dried before a second color can be applied. In addition, the water based speckles can bleed and/or smear on the product during drying, and may be transferred to other confectioneries in a batch. Moreover, water based speckles cannot be used with edible materials having a porous surface, such as baked goods and animal food products. A solution to this problem is to use solvent based printing inks and/or dye/Lake solutions. However, such inks are flammable and/or toxic, and, thus, are health and fire risks.

A need exists for decorated products having added color that provides an exciting and colorful appearance for promotions and customized products and a method of making such products in which more than one color can be applied in a single application with a water based dye or Lake. The present invention provides such decorated products and methods.

### SUMMARY OF THE INVENTION

The present invention is directed to a decorated food product having added color that provides an exciting and colorful appearance for promotions and customized products. The decorated food product comprises an edible product, and an edible glitter affixed to the edible product by an edible adhesive. The edible glitter preferably comprises a food grade colorant and at least one of a sugar, a non-caloric sweetener, a gum, a gelatin, and a polysaccharide. Preferably, the edible adhesive comprises a sugar or a monosaccharide, such as sucrose, a polysaccharide, such as dextrin, or combination thereof, and is an aqueous solution or suspension prior to drying. Edible products useful in the invention include, but are not limited to confectioneries, baked goods, and animal food products. Decorated food products in accordance with the invention may be made by applying an edible adhesive to an edible product, and applying an edible glitter to the adhesive, thereby affixing the edible glitter to the edible product, and forming a decorated food product.

### BRIEF DESCRIPTION OF THE DRAWINGS

FIG. 1 is a cross-sectional illustration of a shelled confectionery of the invention;

FIG. 2 is a side view of the shelled confectionery of FIG. 1; and

FIG. 3 is a plan view of a animal treat of the invention.

### DETAILED DESCRIPTION OF THE INVENTION

As used herein, the terms “particles” and “particulates” refer to particles, flakes, granules, and the like that may be applied to a food product with the method of the invention. Particles may have any symmetric or asymmetric geometric shape.

The present invention is directed to food products, such as confectioneries and animal foods, such as pet treats, decorated with an edible glitter, and to a method of making such decorated products. As used herein, the term “edible glitter” refers to edible particles that may be affixed to the surface of a confectionery with an edible adhesive to provide a colorful decorative appearance. Particles of edible glitter may be of any useful size, depending upon the decorated edible product, and may be shaped, printed, and/or decorated. For example, preferably, for shelled confectioneries no more than about 5 percent of the particulates will to pass through an ASTM 40 mesh sieve, and no less than 98 percent of the particulates will be able to pass through an ASTM 4 mesh sieve. More preferably, no more than 15 percent of the edible glitter particles will pass through an ASTM 20 mesh sieve, and no more than 5 percent of the particulates will be able to pass through an ASTM 40 mesh sieve. The ASTM mesh size refers to the number of mesh openings per inch. Typically, a 4 mesh sieve has an open area of 65.9 percent and an opening size of 5,160 μm, a 20 mesh sieve has an open area of 46.2 percent and an opening size of 860 μm, and a 40 mesh sieve has an open area of 36 percent and an opening size of 380 μm.

The most preferred edible glitter is a food colored gum Arabic product available from Warner Jenkinson, Inc., St. Louis, Mo. The Warner Jenkinson glitter is a multi-colored mix of water-soluble film particulates, containing gum Arabic, polysorbate 80, beet juice, titanium dioxide, and a colorant. Colorants used in the Warner Jenkinson glitter include FD&C Yellow 5 Lake, FD&C Yellow 6 Lake, FD&C Blue 1 Lake, FD&C Blue 1 dye, and FD&C Red 40 dye. Other useful glitters include particles of sugars, non-caloric sweeteners, gums, gelatin, starches, and the like, colored with a food grade colorant. Useful food grade colorants for use in glitter include those used in the Warner Jenkinson glitter, as well as natural colorants that are preferably water soluble. The colorant can be derived from sources that include, but are not limited to, fruit juice concentrates or extracts, plant concentrates or extracts, vegetable juices, carotene, annato, carmine, and cochineal. However, all food colorants, as permitted for use for food, both present and future, in the Code of Federal Regulations, both certified and exempt from certification, may be used in the invention. Edible glitter may also contain fortification ingredients, such as herbs and other dietary supplements, such as vitamins.

Useful edible adhesives include mixtures of one or more sugars, water and a polysaccharide, such as gum Arabic, guar gum, carrageenan, dextrin, cyclodextrin, starches, and pectins. The polysaccharide is preferably a hydrocolloid or dextrin. Preferred edible adhesives are solutions of a sugar and a polysaccharide, where useful sugars include sucrose, one or more corn syrups, maltodextrin, and invert, and useful polysaccharides include dextrin. Most preferably, the edible adhesive is a solution of sucrose and dextrin in water. Preferred edible adhesive solutions comprise from about 30 to about 70 percent by weight water, about 35 to about 50 percent by weight sugar, and about 5 to about 25 percent by weight polysaccharide. More preferably, the edible adhesive comprises from about 30 to about 50 percent by weight water, from about 35 to about 45 percent by weight sugar, and from about 10 to about 25 percent by weight polysaccharide. An edible adhesive, particularly useful with sugar shelled confectioneries, comprises about 41.1 percent liquid sucrose at about 67 percent solids, about 19.2 percent dextrin, and about 39.7 percent water.

Food products that can be decorated in accordance with the invention include, but are not limited to baked products, confectioneries and other sugar-based products, animal foods, main meal and snack food products, pharmaceutical products, vegetables, fruits, produce, meat, poultry, eggs, dairy products, frozen foods, ice creams, and fried products.

Confectioneries in accordance with the invention include chocolate candies and bars, jellies, gummy centers, such as gummy bears and gum drops, jelly beans, hard candies, such as lollipops, and pet treats. The confectionery may be shelled or unshelled, such as with a sugar shell. The confectioneries may be formed and, optionally, coated by any means known in the art. For example, confectioneries may be molded or extruded, and coated by dipping, with an enrober, or in a coating pan.

Decorated food products in accordance with the invention may be prepared by applying an edible adhesive to a food product, preferably in an amount sufficient to wet the surface of the food product. The adhesive may be applied by any means known in the art, such as spraying, dosing, and dipping. Before the wet adhesive dries, the edible glitter is distributed onto the food product by any means known in the art, including manually and with a blower. Once the glitter is applied, the adhesive is dried, such as with a current of drying gas, which is preferably dry air. The dry confectionery can then be coated, such as with an edible wax, to seal the glitter onto the confectionery. Alternatively, the edible glitter may be mixed with the edible adhesive and the mixture applied to the food product.

The preferred confectionery is a shelled candy, produced in a panning apparatus. For example, a mass of chocolate centers are first sugar coated in a panning apparatus to provide a sugar shell and, optionally, a color coat. The coated centers are dried with a flow of drying gas after the application of each of the coats. Once the shelled centers are dried, the air flow in the panning vessel is preferably discontinued. Edible adhesive, preferably in an amount of sufficient to wet the surface of the shelled centers, is then added to the centers in the panning vessel. For example, for a 2,000 kg batch of coated chocolate centers, from about 1 to about 30 liters, preferably from about 5 to about 9 liters, and most preferably about 7 liters, of edible adhesive are required. The preferred adhesive for this embodiment, as discussed above, comprises about 41.1 percent liquid sucrose at about 67 percent solids, about 19.2 percent dextrin, and about 39.7 percent water. Once the sugar coated centers are relatively evenly coated with the edible adhesive, the edible glitter is introduced into the panning vessel in amount of from about 1 kg to about 500 kg, preferably, from about 10 kg to 30 kg, and, most preferably, about 15 kg to 2,000 kg of coated centers. This may be accomplished manually, with a blower, or by any other means known in the art for introducing material into a panning apparatus. The coated centers are then panned for a period of time sufficient to evenly distribute the glitter onto all of the confectioneries in the pan. Typically, this requires no more than about 2 to about 5 minutes. Once the glitter is evenly distributed and completely adhered to the confectioneries in the pan, the drying gas is again introduced into the pan. Typically, during the drying of the edible adhesive, as well as the drying of the shells and color coats, the temperature and humidity of the air is controlled. Preferably, the air is maintained at a temperature of from about 20 to about 23° C. and a relative humidity of from about 30 to about 40 percent for confectioneries, and at a temperature of from about 20 to about 240° C. for baked goods and a relative humidity of from about 30 to about 40 percent. However, for confectioneries, depending on the type of center and shell, a temperature of from about 3 to about 50° C. and a relative humidity of from about 5 to about 80 percent may be used. For baked goods, a temperature of from about 20 to about 240° C., and a relative humidity of from about 5 to about 80 percent may be used.

Typically, the drying of the adhesive takes about 2 to about 10 minutes, so that the additional processing time for a 2000 kg batch of confectioneries is only about 5 to about 15 minutes with the size, amount, and color of the glitter completely controlled. Moreover, in contrast to prior art methods, which required the application of a single color and, thus, multiple steps, the present invention provides for the application of multiple colors in a single step.

For example, in the preferred method for the application of glitter to sugar shelled chocolates, the glitter is applied in the pan used to shell the chocolate, and the shell is typically dried of all surface moisture with the pan running at about 3.5 rpm. An edible adhesive solution, comprising water, sugar and dextrin, is applied to the product with the pan running at 5.5 rpm, and rolled into the shelled product for approximately 1 minute to assure that all pieces are evenly coated. The edible glitter is then applied using a air driven blower without the application of drying air into the pan. For 2,000 kg of milk centers, 30 pounds of glitter is distributed for a period of 5 minutes, after which the drying air is applied to the product inside the pan for an additional 2 minutes. Preferably, another application of the edible adhesive is applied on top of the glitter coated product to seal the surface. The solution is rolled on the decorated product for a period of 1 minute without applying drying, and a carnauba wax is applied and rolled into the product for an additional minute. Drying air is again applied after the roll in cycle is completed. The product remains tumbling in the pan with the air on for another 10 minutes before transfer to a solid wall polishing tube. In the polishing tube, the carnauba wax is applied to the decorated product, and rolled for up to 30 minutes with the application of air to provide a highly glossed surface.

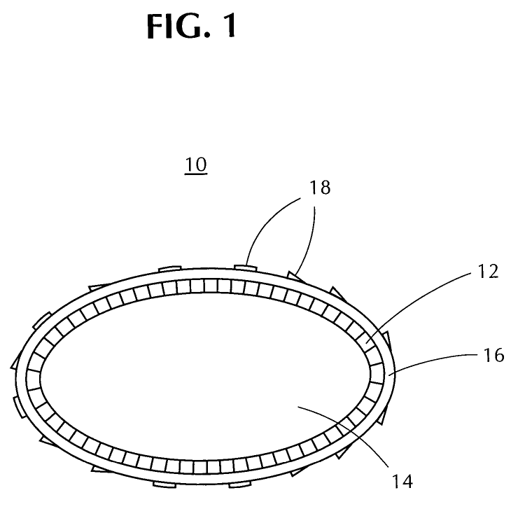

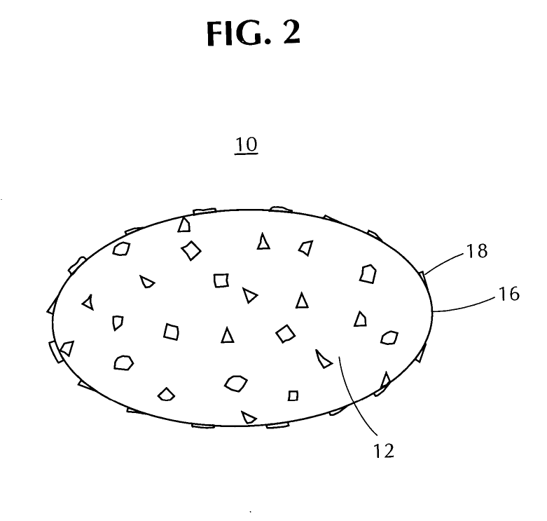

A decorated, shelled confectionery 10 is illustrated in cross-section in FIG. 1, and in plan view in FIG. 2. The confectionery 10 comprises an outer shell 12, filled with a confectionery 14, such as chocolate. The outer shell 12 is overcoated with a layer of edible adhesive 16 that is used to affix particles of edible glitter 18 to the shell 12. As illustrated in FIGS. 1 and 2, the particles 18 may have various different symmetric and asymmetric geometric shapes. However, it will be understood that any combination of shapes may be used. For example, any number of particles, including all of the particles, may have the same shape, or all of the particles may be different.

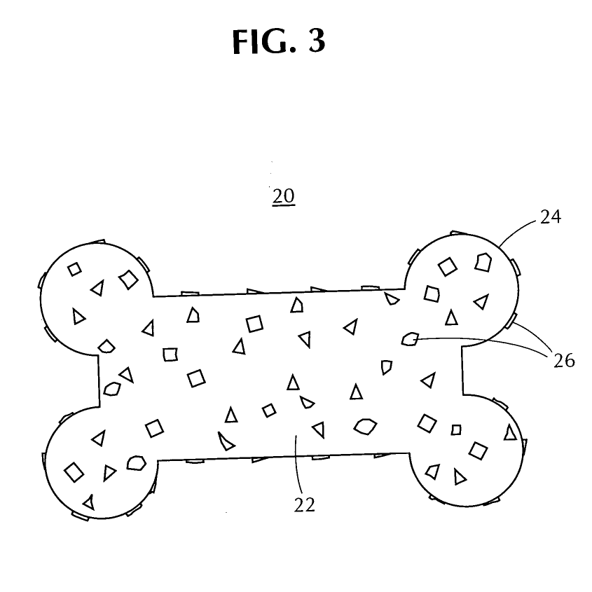

A animal treat 20, decorated in accordance with the invention is illustrated in FIG. 3. The animal treat 20 comprises a animal biscuit 22, coated with a layer of edible adhesive 24. Particles of edible glitter 26 are affixed to the biscuit 22 by the edible adhesive 24.

This invention is not limited by the embodiments disclosed herein, and it will be appreciated that numerous modifications and embodiments may be devised by those skilled in the art. Therefore, it is intended that the appended claims cover all such modifications and embodiments that fall within the true spirit and scope of the present invention.

What is claimed is:

1. A decorated shelled confectionery, comprising:
a confectionery center;
a shell surrounding the center, and having an outer surface; and
an edible glitter affixed to the outer surface with an edible adhesive, wherein the edible adhesive comprises a sugar and a polysaccharide.

2. The decorated shelled confectionery of claim 1, wherein the shell is a sugar shell.

3. The decorated shelled confectionery of claim 1, wherein the sugar is sucrose.

4. The decorated shelled confectionery of claim 1, wherein the polysaccharide is selected form the group consisting of gum Arabic, guar gum, cyclodextrin, dextrin, carrageenan, agar, starches, and pectins.

5. The decorated shelled confectionery of claim 1, wherein the edible glitter comprises a food grade colorant and at least one of a gum, a sugar, a non-caloric sweetener, a gelatin, or a polysaccharide.

6. The decorated shelled confectionery of claim 1, wherein the edible adhesive comprises sugar and dextrin, and the edible glitter comprises gum Arabic and a food grade colorant.

7. The decorated shelled confectionery of claim 1, wherein, before drying, the edible adhesive comprises from about 30 to about 70 percent by weight water, about 35 to about 50 percent by weight sugar, and about 5 to about 25 percent by weight polysaccharide.

8. The decorated shelled confectionery of claim 1, wherein, before drying, the edible adhesive comprises about 41.1 percent liquid sucrose at about 67 percent solids, about 19.2 percent dextrin, and about 39.7 percent water.

9. A decorated food product, comprising:
an edible product; and
an edible glitter affixed to the edible product by an edible adhesive; wherein the edible glitter comprises a food grade colorant and at least one of a sugar, a non-caloric sweetener, a gum, a gelatin, and a polysaccharide, and the edible adhesive comprises a sugar and a polysaccharide.

10. The decorated food product of claim 9, wherein the edible glitter comprises a food grade colorant and gum Arabic and the edible adhesive comprises sucrose and dextrin.

11. The decorated food product of claim 9, wherein the edible product is a confectionery.

12. The decorated food product of claim 9, wherein, before drying, the edible adhesive comprises an aqueous solution of a sugar and a polysaccharide.

13. The decorated food product of claim 9, wherein, before drying, the edible adhesive comprises from about 30 to about 70 percent by weight water, about 35 to about 50 percent by weight sugar, and about 5 to about 25 percent by weight polysaccharide.

14. The decorated food product of claim 9, wherein the edible product is an animal food product.

15. A method of making a decorated food product, the method comprising:
applying an edible adhesive and an edible glitter to an outer surface of an edible product to form a decorated food product;
wherein the glitter comprises a food grade colorant and at least one of a gum, a sugar, a non-caloric sweetener, a gelatin, or a polysaccharide.

16. The method of claim 15, wherein the edible adhesive is applied to the food product prior to applying the edible glitter.

17. The method of claim 15, wherein the edible adhesive and the edible glitter are admixed prior to application to the food product.

18. The method of claim 15, wherein the edible adhesive comprises a sugar and a polysaccharide.

19. The method of claim 15, wherein the sugar is sucrose.

20. The method of claim 15, wherein the polysaccharide is selected from the group consisting of gum Arabic, guar gum, cyclodextrin, dextrin, carrageenan, agar, starches, and pectins.

21. A method of making decorated confectioneries, the method comprising:
providing a mass of confectionery centers in a coating pan, each of the centers having an outer shell;
introducing an edible adhesive into the pan, thereby coating the mass of centers with the edible adhesive;
introducing an edible glitter into the pan;
panning the mass of centers to distribute the edible glitter on the mass of centers; and
drying the edible adhesive on the confectionery centers.

22. The method of claim 21, wherein the edible adhesive is introduced in the pan in an amount sufficient to wet the shelled centers.

23. The method of claim 21, further comprising introducing a flow of drying gas into the pan after the edible glitter is distributed onto the mass of shelled confectioneries.

24. The method of claim 21, further comprising sealing the glitter onto the confectionery with an edible material.

25. The method of claim 24, wherein the edible material is a wax.

26. A method of making decorated confectioneries, the method comprising:
applying an edible adhesive and an edible glitter to a mass of confectionery centers in a coating pan to form decorated confectioneries;
wherein the glitter comprises a food grade colorant and at least one of a gum, a sugar, a non-caloric sweetener, a gelatin, or a polysaccharide.

27. The method of claim 26, wherein the edible adhesive is applied to the food product prior to applying the edible glitter.

28. The method of claim 26, wherein the edible adhesive and the edible glitter are admixed prior to application to the food product.

29. The method of claim 26, wherein the edible adhesive comprises a sugar and a polysaccharide.

30. The method of claim 26, wherein the sugar is sucrose.

31. The method of claim 26, wherein the polysaccharide is selected from the group consisting of gum Arabic, guar gum, cyclodextrin, dextrin, carrageenan, agar, starches, and pectins.
